(19) United States
(12) Patent Application Publication
(10) Pub. No.: US 2015/0019095 A1
(43) Pub. Date: Jan. 15, 2015

(54) 2-SPEED TRANSMISSION CLUTCH LEARNING SYSTEM FOR HYBRID VEHICLE AND METHOD THEREOF

(71) Applicants: Kia Motors Corporation, Seoul (KR); Hyundai Motor Company, Seoul (KR)

(72) Inventors: Seung Ki Kong, Hwaseong-si (KR); Ki Nam Kim, Seongnam-si (KR); Sanghyun Jeong, Hwaseong-si (KR); Jaeshin Yi, Suwon-si (KR); Chulmin Ahn, Busan (KR)

(73) Assignees: Kia Motors Corporation, Seoul (KR); Hyundai Motor Company, Seoul (KR)

(21) Appl. No.: 14/145,399

(22) Filed: Dec. 31, 2013

(30) Foreign Application Priority Data
Jul. 11, 2013 (KR) 10-2013-0081599

(51) Int. Cl. F16D 48/06

(52) U.S. Cl. CPC F16D 48/06
USPC 701/67

(57) ABSTRACT

A 2-speed transmission clutch learning method for a hybrid electric vehicle may include detecting whether the 2-speed transmission clutch may be operated through an actuator by driving a motor, learning an open position, a slip position, and a lock-up position of the 2-speed transmission clutch by detecting the amount of driving current and the rotation speed of the motor for the operation of the 2-speed transmission clutch, and storing learning values of the open position, the slip position, and the lock-up position of the 2-speed transmission clutch into a memory area, and controlling the operation of the 2-speed transmission clutch by applying the learning values.

### CROSS-REFERENCE TO RELATED APPLICATION

The present application claims priority to Korean Patent Application No. 10-2013-0081599 filed on Jul. 11, 2013, the entire contents of which is incorporated herein for all purposes by this reference.

### BACKGROUND OF THE INVENTION

1. Field of the Invention

The present invention relates to a 2-speed transmission learning system that secures accurate and stable control by learning and storing an open position, a slip position, and a lock-up position in control of a 2-speed transmission 1/2-stage inside clutch used for hybrid electric vehicles, and a method thereof.

2. Description of Related Art

Control of a 2-speed transmission 1/2-stage inside clutch used for hybrid electric vehicles and electric vehicles is made by driving a lead screw type actuator such that the 1/2-stage can be engaged/disengaged.

The 2-speed transmission 1/2-stage inside clutch is usually a dry clutch, such that the disk is worn and the spring coefficient of a diaphragm is reduced, as time passes.

Accordingly, the lead screw type actuator fails to completely connect/disconnect power due to abrasion of the 1/2-stage clutch when operating a clutch, such that gears are not stably engaged/disengaged and shift feel may be deteriorated.

Further, since a learning function for the operation of the 2-speed transmission 1/2-stage inside clutch is not provided, it is difficult to accurately control the open position, the slip position, and the lock-up position of the clutch and the null position is not clearly set, such that an unidentified acceleration may be caused when starting the engine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing accurate and stable control by learning and storing an open position, a slip position, and a lock-up position in control of a 2-speed transmission 1/2-stage inside clutch used for hybrid electric vehicles.

Further, the present invention provides stabilization of a system by preventing unidentified acceleration when starting an engine, by keeping setting an actuator, which operates a clutch in initialization with an ignition key at OFF, at a null position.

An exemplary embodiment of the present invention provides a -speed transmission 1/2 inside clutch learning system including a motor, an actuator connected to a rotary shaft of the motor, and a shift controller operating the 2-speed transmission clutch through the actuator by driving the motor, in which the shift controller learns and stores an open position, a slip position, and a lock-up position of the 2-speed transmission clutch into a memory area when operating the 2-speed transmission clutch by driving the motor, and controls the operation of the 2-speed transmission clutch by applying the learning values.

The shift controller may learn the open position, the slip position, and the lock-up position of the 2-speed transmission cutch from the amount of current for operating the motor and the rotation speed of the motor.

The shift controller may provide the result of learning the open position, the slip position, and the lock-up position of the 2-speed transmission clutch to a vehicle controller, using CAN communication.

When the system is initialized by starting-off by an ignition key, the shift controller may prevent unidentified acceleration in restarting, by setting the actuator to a null position.

The actuator may include a lead screw connected to the rotary shaft of the motor, a moving body engaged with the lead screw, and a rod with one end connected to the moving body and the other end connected to a 2-speed transmission clutch pedal.

Another exemplary embodiment of the present invention provides a 2-speed transmission clutch learning method for a hybrid electric vehicle, which may include detecting whether the 2-speed transmission clutch is operated through an actuator by driving a motor, learning an open position, a slip position, and a lock-up position of the 2-speed transmission clutch by detecting the amount of driving current and the rotation speed of the motor for the operation of the 2-speed transmission clutch, and DeletedTextsstoring learning values of the open position, the slip position, and the lock-up position of the 2-speed transmission clutch into a memory area, and controlling the operation of the 2-speed transmission clutch by applying the learning values.

The method may further include preventing unidentified acceleration in restarting by setting the actuator to a null position, when the system is initialized by starting-off by an ignition key.

The learning result of the open position, the slip position, and the lock-up position of the 2-speed transmission clutch may be provided to a vehicle controller, which is a higher rank controller, using CAN communication.

As described above, by learning the open position, the slip position, and the lock-up position in accordance with abrasion of the 2-speed transmission inside 1/2-stage clutch in a hybrid electric vehicle or an electric vehicle, it is possible to provide accurate and stable control and improve stability and reliability in traveling.

Further, when the system is initialized by starting-off by an ignition key, the lead screw type actuator operating the clutch is set to the null position, such that accuracy in control of the clutch can be provided and unidentified acceleration in starting can be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating a 2-speed transmission clutch learning system for a hybrid electric vehicle according to an exemplary embodiment of the present invention.

FIG. 2 is a diagram schematically illustrating a 2-speed transmission clutch learning process for a hybrid electric vehicle according to an exemplary embodiment of the present invention.

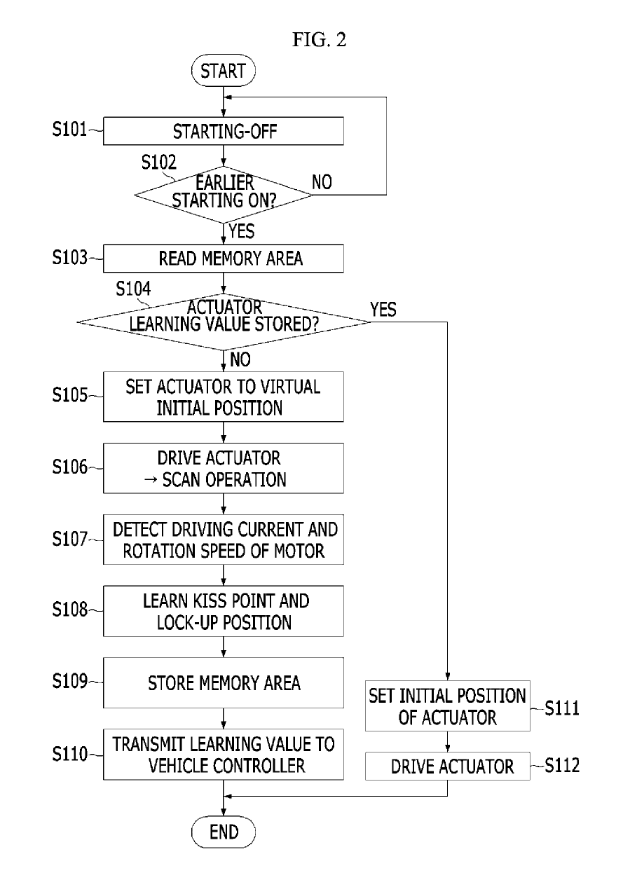

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

The unrelated parts to the description of the exemplary embodiments are not shown to make the description clear and like reference numerals designate like element throughout the specification.

The configurations are optionally shown in the drawings for the convenience of description and the present invention is not limited to the drawings.

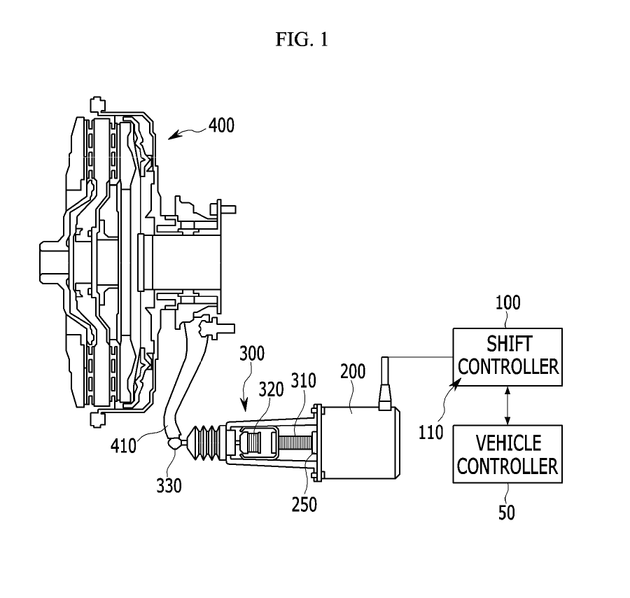

FIG. 1 is a diagram schematically illustrating a 2-speed transmission clutch learning system for a hybrid electric vehicle according to an exemplary embodiment of the present invention.

Referring to FIG. 1, an exemplary embodiment of the present invention includes a shift controller 100, a motor 200, an actuator 300, and a clutch 400.

The shift controller 100 operates the clutch 400 through the actuator 300 by operating the motor 200 in response to a request for a vehicle controller 50 that is a higher rank controller.

The clutch 400 means a 2-speed transmission 1/2-stage inside clutch.

When the vehicle controller 50, which is a higher rank controller, detects starting of an engine by an ignition key, the shift controller 100 determines whether learning values of an open position, a slip position, and a lock-up position for control of the clutch 300 are stored, by searching a memory area 110.

When there is no learning values for control of the clutch 400 stored in the memory area 110, the shift controller 100 learns and stores the open position, the slip position, and the lock-up position of the clutch 400 into the memory area 110, by detecting the amount of current supplied to the motor 200 and the rotation speed of the motor 200 when operating the clutch 400 through the actuator 300 by operating the motor 200.

That is, it learns and stores the open position, the slip position, and the lock-up position of the clutch 400 into the memory area 110, from the amount of operation current and the rotation speed of the motor 200 moving the actuator 300.

The shift controller 100 provides the learning result including the open position, the slip position, and the lock-up position of the clutch 400 stored in the memory area to the vehicle controller, using CAN communication.

The shift controller 100 prevents unidentified acceleration in restarting of an engine by setting the actuator 300 to the null position when the system is initialized in accordance with the starting-off by the ignition key by scanning the initial position.

When the open position, the slip position, and the lock-up position of the clutch 400 are stored in the memory area, the shift controller 100 controls the operation of the clutch 400 by applying the learning values.

The motor is a Brushless Direct Current (BLDC) type motor and operates the actuator 300 connected to a rotary shaft 250 by operating in accordance with the amount of current supplied from the shift controller 100.

In the actuator 300, a lead screw 310 connected to a rotary shaft operates with the operation of the motor 200, a moving body 320 engaged with the lead screw 310 moves with rotation of the lead screw 310, and a rod 330 with one end connected to the moving body 320 and the other end connected to a clutch pedal 410 operates the clutch pedal 410, thereby connecting/disconnecting power.

The operation of the present invention having the functions described above is as follows.

The shift controller 100 for a hybrid electric vehicle or an electric vehicle of the present invention determines whether starting-on by an ignition key is detected from the vehicle controller that is a higher rank controller (S102), in a standby state for shift control in accordance with starting-off by the ignition key (S101).

When starting-on is detected by the vehicle controller in S102, the shift controller 100 determines whether learning values including the open position, the slip position, and the lock-up position for control of the clutch 400 (S104) have been stored, by reading out the memory area (S103).

When there is no learning value for control of the clutch 400 in the memory area in S104, the shift controller 100 sets the actuator 300 to a virtual initial position by operating the motor 200 (S105).

The virtual initial position of the actuator 300 may be set at 5 mm from a stopper, for example.

When the virtual initial position of the actuator 300 is set, the shift controller 100 operates the clutch 400 by driving the actuator 300 through the motor 200 (S106).

In this process, the shift controller 100 scans the operation of the actuator 300 and detects the amount of current supplied to the motor 200 and the rotation speed of the motor 200 (S107).

Further, the shift controller 100 learns and stores the open position, the slip position, and the lock-up position of the clutch 400 according to the amount of current supplied to the motor 200 and the rotation speed of the motor 200 into the memory area (S108) (S109).

That is, it learns and stores the open position, the slip position, and the lock-up position of the clutch 400 into the memory area, from the amount of operation current and the rotation speed of the motor 200 moving the actuator 300.

Thereafter, the shift controller 100 provides the learning result including the open position, the slip position, and the lock-up position of the clutch 400 stored in the memory area to the vehicle controller, using CAN communication (S110).

Further, when the open position, the slip position, and the lock-up position of the clutch 400 are learned and stored in the memory area in S104, the shift controller 100 sets the initial position of the actuator 300 by applying the learning values (S111) and controls the operation position of the clutch 400 by driving the actuator 300 through the motor 200 (S112).

The shift controller 100 prevents unidentified acceleration in restarting of an engine by setting the actuator 300 to the null position when the system is initialized in accordance with the starting-off of the ignition key.

It was exemplified above that the motor 200 operating the actuator 300 is a BLDC motor, and position compensation may be provided in the same or similar method by a DC motor that can detect the movement distance of the actuator 300, using a linear position sensor or a hole sensor.

Further, the shift controller 100 enters a fail safe and provides fail-safe traveling, when a fail is generated in the shift system including the motor 200 and the actuator 300.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A 2-speed transmission 1/2 inside clutch learning system, comprising:
a motor;
an actuator connected to a rotary shaft of the motor; and
a shift controller operating a 2-speed transmission clutch through the actuator by driving the motor,
wherein the shift controller learns and stores an open position, a slip position, and a lock-up position of the 2-speed transmission clutch into a memory area when operating the 2-speed transmission clutch by driving the motor, and controls an operation of the 2-speed transmission clutch by applying the learning values.

2. The system of claim 1, wherein the shift controller learns the open position, the slip position, and the lock-up position of the 2-speed transmission cutch from an amount of current for operating the motor and a rotation speed of the motor.

3. The system of claim 1, wherein the shift controller provides a result of learning the open position, the slip position, and the lock-up position of the 2-speed transmission clutch to a vehicle controller, using CAN communication.

4. The system of claim 1, wherein when the system is initialized by starting-off by an ignition key, the shift controller prevents unidentified acceleration in restarting, by setting the actuator to a null position.

5. The system of claim 1, wherein the actuator includes:
a lead screw connected to the rotary shaft of the motor;
a moving body engaged with the lead screw; and
a rod with one end connected to the moving body and the other end thereof connected to a 2-speed transmission clutch pedal which is coupled to the 2-speed transmission clutch.

6. A 2-speed transmission clutch learning method for a hybrid electric vehicle, the method comprising:
detecting whether a 2-speed transmission clutch is operated through an actuator by driving a motor;
learning an open position, a slip position, and a lock-up position of the 2-speed transmission clutch by detecting an amount of driving current and a rotation speed of the motor for the operation of the 2-speed transmission clutch; and
storing learning values of the open position, the slip position, and the lock-up position of the 2-speed transmission clutch into a memory area, and controlling the operation of the 2-speed transmission clutch by applying the learning values.

7. The method of claim 6, further comprising preventing unidentified acceleration in restarting by setting the actuator to a null position, when the system is initialized by starting-off by an ignition key.

8. The method of claim 6, wherein the learning result of the open position, the slip position, and the lock-up position of the 2-speed transmission clutch is provided to a vehicle controller, which is a higher rank controller, using CAN communication.

9. A 2-speed transmission clutch learning system for a hybrid electric vehicle, the system comprising:
a motor;
an actuator connected to a rotary shaft of the motor; and
a shift control unit operating a 2-speed transmission clutch through an actuator by driving the motor,
wherein the shift control unit learns a control position of the 2-speed transmission clutch by performing claim 6, by operating in accordance with a predetermined program.
